(19) United States
(12) Patent Application Publication
(10) Pub. No.: US 2020/0068200 A1
(43) Pub. Date: Feb. 27, 2020

(54) METHODS AND APPARATUSES FOR ENCODING AND DECODING VIDEO BASED ON PERCEPTUAL METRIC CLASSIFICATION

(71) Applicant: InterDigital VC Holdings, Inc., Wilmington, DE (US)

(72) Inventors: Franck GALPIN, Thorigné-Fouillard (FR); Fabrice LELEANNEC, Mouazé (FR); Fabien RACAPE, San Francisco, CA (US); Tangi POIRIER, Thorigné-Fouillard (FR); Thierry VIELLARD, OSSE (FR); Fabrice URBAN, Thorigné-Fouillard (FR)

(21) Appl. No.: 16/346,826

(22) PCT Filed: Nov. 21, 2017
(86) PCT No.: PCT/EP2017/079867

§ 371 Date: May 1, 2019

(30) Foreign Application Priority Data
Nov. 23, 2016 (EP) 16306542.8

(51) Int. Cl. H04N 19/147; H04N 19/196; H04N 19/159; H04N 19/105; H04N 19/176; G06K 9/62

(52) U.S. Cl. CPC H04N 19/147; H04N 19/196; H04N 19/159; G06K 9/6272; H04N 19/176; G06K 9/6223; H04N 19/105

(57) ABSTRACT

Methods and apparatuses for encoding and decoding video are disclosed. The method of encoding video includes assigning (12) a distortion versus quantization curve to a block in a picture of a video based on a perceptual metric classification of the block, determining a quantization parameter (132) for the block based on the distortion versus quantization curve and a target distortion for the block, the target distortion being an overall target distortion for the picture and encoding (16) the block based on the quantization parameter. A bitstream formatted to include encoded data, and computer-readable storage mediums and computer-readable program products for encoding and decoding video are also disclosed.

### 1. TECHNICAL FIELD

The present embodiments generally relate to video encoding and decoding based on a perceptual metric classification.

### 2. BACKGROUND ART

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Digital images and video sequence need a lot of resources for storage and transmission and thus image and video compression techniques are needed for reducing bandwidth and storage space.

Video coding schemes are already known, such as HEVC (“High Efficiency Video Coding) or VP9. In such schemes, a video sequence is coded picture by picture. Each picture is decomposed into a set of blocks. In order to reduce the number of bits used for coding each block, such schemes perform lossy coding using a quantization tool that compresses a range of values to a single quantum value.

In video compression schemes, such as VP8 or VP9 for instance, rate/distortion optimization is performed on the encoder side for determining the best compromise between rate and distortion when coding each block of a picture. Such rate/distortion optimization may adapt a quantization parameter at a block level to precisely control the rate and the distortion of a block to encode. Classically, the distortion is measured at the block level using an objective measure such as PSNR (Peak Signal to Noise Ratio) or MSE (Mean Square Error). However, such measures do not take into account the properties of the Human Visual System, and result in compressed video wherein picture quality is not homogeneous.

### 3. SUMMARY

According to an aspect of the present disclosure, a method for encoding a video is disclosed, including assigning a distortion versus quantization curve to a block in a picture of a video based on a perceptual metric classification of the block, determining a quantization parameter for the block based on the curve and a target distortion for the block, the target distortion being an overall target distortion for the picture and encoding the block based on the quantization parameter.

According to an aspect of the present disclosure, an apparatus for encoding video is disclosed including means for assigning a distortion versus quantization curve to a block in a picture of a video based on a perceptual metric classification of the block, means for determining a quantization parameter for the block based on the curve and a target distortion for the block, the target distortion being an overall target distortion for the picture and means for encoding the block based on the quantization parameter.

According to an aspect of the present disclosure, a method for decoding a video is disclosed, including retrieving a quantization parameter for a block of a picture of an encoded video bitstream, the quantization parameter being based on a distortion versus quantization curve for the block and a target distortion for the block, the curve being determined based on a perceptual metric classification of the block, the target distortion being an overall target distortion for the picture and decoding the block based on the quantization parameter.

According to an aspect of the present disclosure, an apparatus for decoding a video is disclosed including means for retrieving a quantization parameter for a block of a picture of an encoded video bitstream, the quantization parameter being based on a distortion versus quantization curve for the block and a target distortion for the block, the curve being determined based on a perceptual metric classification of the block, the target distortion being an overall target distortion for the picture and means for decoding the block based on the quantization parameter.

According to an aspect of the present disclosure, a bitstream formatted to include encoded data representative of a block of a picture is disclosed, the encoded data encoded according to any of the embodiments of the method for encoding video.

According to an aspect of the present disclosure, an computer-readable program product is disclosed including program code instructions for performing any of the embodiments of the method for encoding video.

According to an aspect of the present disclosure, a computer-readable storage medium is disclosed carrying a software program including program code instructions for any of the embodiments of the method of encoding video.

According to an aspect of the present disclosure, an computer-readable program product is disclosed including program code instructions for performing any of the embodiments of the method for decoding video.

According to an aspect of the present disclosure, a computer-readable storage medium is disclosed carrying a software program including program code instructions for any of the embodiments of the method of decoding video.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

Additional features and advantages of the present disclosure will be made apparent from the following detailed description of illustrative embodiments which proceeds with reference to the accompanying figures.

### 4. BRIEF DESCRIPTION OF THE DRAWINGS

The present disclosure may be better understood in accordance with the following exemplary figures briefly described below:

FIG. 1 illustrates a flow diagram of an exemplary method for encoding a picture according to an embodiment of the present principle,

FIG. 2A illustrates a flow diagram of an exemplary method for generating learning data that may be used in the exemplary method for encoding a picture according to an embodiment of the present disclosure,

FIG. 2B illustrates a flow diagram of an exemplary method for generating trajectory curves that may be used in the exemplary method for encoding a picture according to an embodiment of the present disclosure,

FIG. 3 illustrates a simplified example of a trajectory curve according to an embodiment of the present disclosure,

FIG. 4A illustrates a flow diagram of an exemplary method for generating a quantization parameter map according to an embodiment of present disclosure,

FIG. 4B illustrates a flow diagram of an exemplary method for generating a quantization parameter map according to another embodiment of present disclosure,

FIG. 4C illustrates a flow diagram of an exemplary method for generating a quantization parameter map according to another embodiment of present disclosure,

FIG. 5 illustrates a flow diagram of an exemplary method for adapting a quantization parameter map,

FIG. 6 illustrates a simplified example of an admissible range of QP for a given block trajectory,

FIG. 7 illustrates causal neighbors of a block,

FIG. 8 illustrates an example of picture encoding order and reference picture used,

FIG. 9 illustrates a block diagram of an exemplary encoder according to an embodiment of the present disclosure,

FIG. 10 illustrates an exemplary structure of an encoder that may be used in any one of the embodiments disclosed herein, according to an embodiment of the present disclosure.

### 5. DESCRIPTION OF EMBODIMENTS

Classical rate-distortion optimization (RDO) tools aim at allocating a bit budget at a block level when encoding a picture while optimizing the objective quality of the reconstructed block. Such RDO tools are based on objective metrics such as MSE/PSNR. Therefore, the overall objective quality of a picture to encode is optimized with regards to these metrics. However, PSNR does not take into account the properties of the Human Visual System. More coherent bitrate allocation may be performed knowing the sensitivity of human eyes. A higher perceptual/visual quality of the overall content may be achieved by better distributing the compression methods and parameters over the pictures of source video sequences.

The human visual system (HVS) is more sensitive to contrast than absolute luminance. Moreover, the sensitivity depends on the spatial frequency of the picture or region of the picture. This sensitivity decreases on high spatial frequencies, i.e. in detailed textures. This phenomenon is also known as contrast sensitivity.

High frequencies often require a huge amount of bits to be transmitted at a high quality level since they are more difficult to predict. By better distributing the coding parameters when encoding a picture, these highly detailed regions or blocks will be encoded at a lower level of quality, for instance by using a more severe quantization. The subjective quality of the reconstructed picture would not be impacted as the HVS is not able to detect the produced artefacts. The preserved bitrate could then be utilized to enhance the quality of low frequency regions for improving the overall perceived quality.

When solving the problem of perceptual coding, some methods rely on the fact that a particular local “perceptual metric” is available during the encoding stage, allowing the encoder to decide encoding mode (especially the QP of the local block) based on these metrics. Such methods generally rely on a local activity measure to decide the coding mode. A problem with these approaches is that the perceptual quality of a block is very difficult to measure locally (i.e. taking into account only the pixels inside the bloc), and the best perceptual metrics (for example VQM, WQA for Wavelet-based Quality Assessment, etc.) use a global approach to obtain the metric of each pixel.

In practice, it means that during the encoding stage, one cannot compute these perceptual metrics on-the-fly based on the result of the encoding of the current block (typically during the RDO). An alternative is to perform a so-called “first pass” in order to choose some suitable quantization parameters (QPs) prior to the encoding stage.

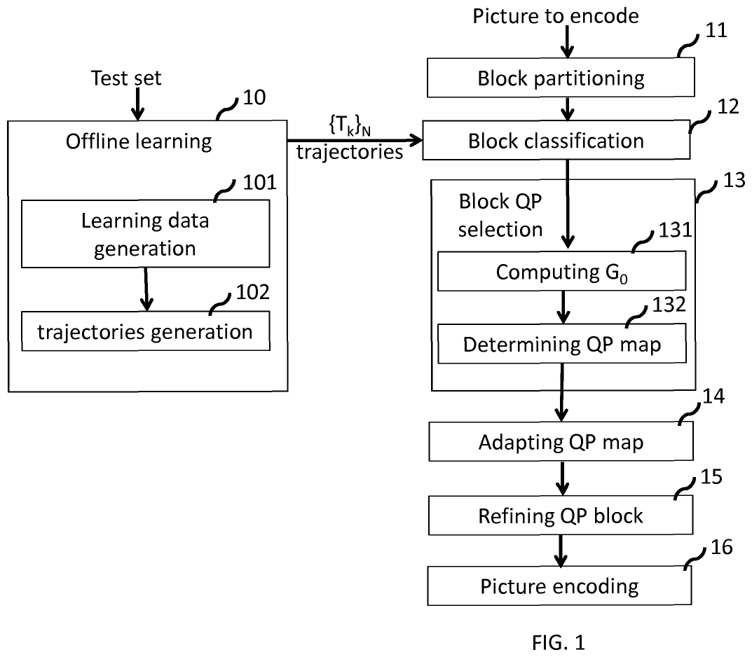

FIG. 1 illustrates a flow diagram of an exemplary method for encoding a picture according to an embodiment of the present disclosure. In step 10, an offline learning method is performed to compute a set of trajectories curves or D-Q curves. A trajectory curve allows representing for a given block of a picture the change in quality as a function of the quantization parameters. Such offline learning method is performed for a test set of video sequences. The offline learning method delivers a set of N trajectories classes {Tₖ}_{N}={Mₖ(QP)}_{N}, where Mₖ(QP) is a representative function of the class k giving the distortion of a block as a function of the QP.

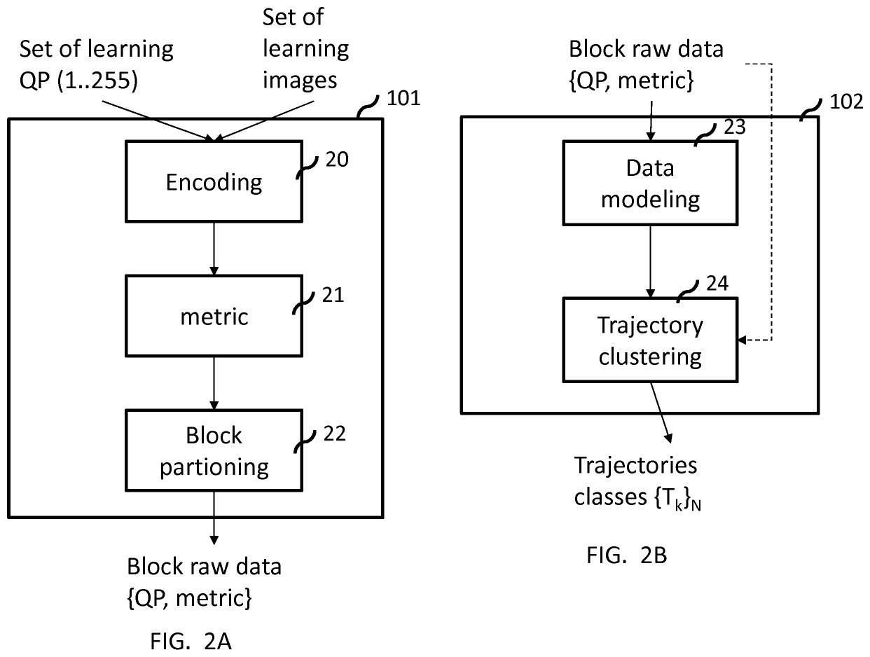

The offline learning method includes generating learning data (step 101) and generating QP(D) trajectories (step 102). Steps 101 and 102 are further described below in relation respectively with FIGS. 2A and 2B.

In step 11, a picture to encode is partitioned into a set of blocks. Typically, 8×8 pixels or 16×16 pixels may be used, but any other region shape for which the QP can be set constant may be used.

In step 12, each block is classified with the set of trajectories classes {Tₖ}_{N} computed in step 10. Such a classification allows associating to each block of the picture a given class k of trajectory from the set {Tₖ}_{N} Such a classification may be performed by performing the steps of the offline learning process to a current block for determining its trajectory curve M_{b} (QP) and associating the class k to the current block which includes the trajectory curve M_{b} (QP) of the block.

According to another variant, each class of trajectories is associated with specific features of blocks, such as textures type, ranges of frequencies, etc. Classification of a current block is then performed by computing or determining the block's features and associating the block to the trajectory class associated with similar features.

In step 13, a quantization parameter is selected for each block of the picture such that the overall distortion of the picture or the overall quality is flattened over the whole picture. Known RDO tools aims at minimizing the distortion given a rate constraint at block level. In contrast, according to the present principle, the distortion is “equalized” over the whole picture.

For this, in step 131, a target overall distortion G₀ is computed or determined for the picture. A same initial quantization parameter QP_{g} is assigned to each block of the picture. Such an initial quantization parameter QP_{g} may be for instance a nominal QP assigned to the picture by the encoder. Then, the distortion for each block is obtained using the trajectory curve of the class associated with the block for QP_{g}. That is for a block associated with a trajectory class k, the distortion is given by Mₖ(QP_{g}).

According to a variant, the target overall distortion G₀ is then computed by averaging the distortions Mₖ(QP_{g}) of the blocks of the picture.

According to another variant, for preserving the same global quality as the quality decided by the encoder to encode the current frame, the target overall distortion G₀ is computed as a combination of a robust absolute perceptual metric and a robust flattening score by:

G₀=Mₖ_50%+a*(Mₖ_99%−Mₖ_50%),

where:
Mₖ_50% is the median distortion score on the picture,
Mₖ_99% is the distortion of the 99% quantile on the picture, i.e. the distortion such that 99% of the blocks are below that threshold,
a is a factor to balance absolute quality and flattening score.

In step 132, a quantization parameter (QP) map is determined for the picture. Such QP map includes for each block of the picture an assigned QP.

As the function Mₖ(QP) is invertible, for each block b of a trajectory class k, a QP_{b} can be assigned to the block b with QP_{b}=Mₖ⁻¹(G₀).

Note that the target quality G₀ can be chosen as any metric, as long as an invertible function M exists representing a relationship between the QP and the distortion. A typical example is to define M simply as the PSNR. In this case, this method will try to give the same local PSNR as the global PSNR. Another metric can be chosen as the WQA score.

In step 16, the picture is then encoded using the QP map determined at step 132. The encoding of the picture is further disclosed in relation with FIG. 10.

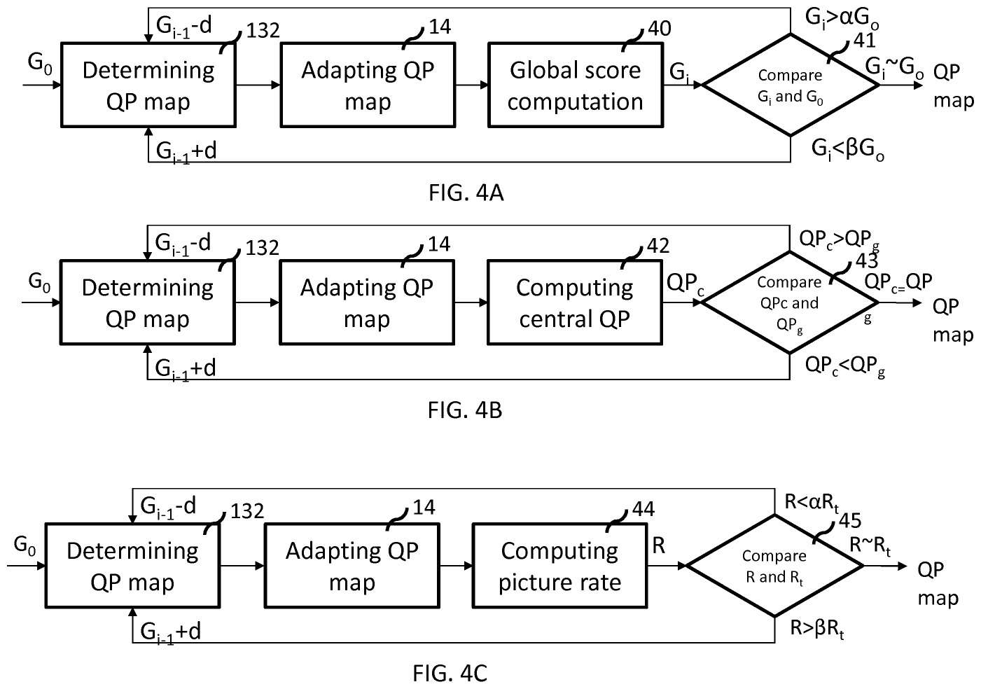

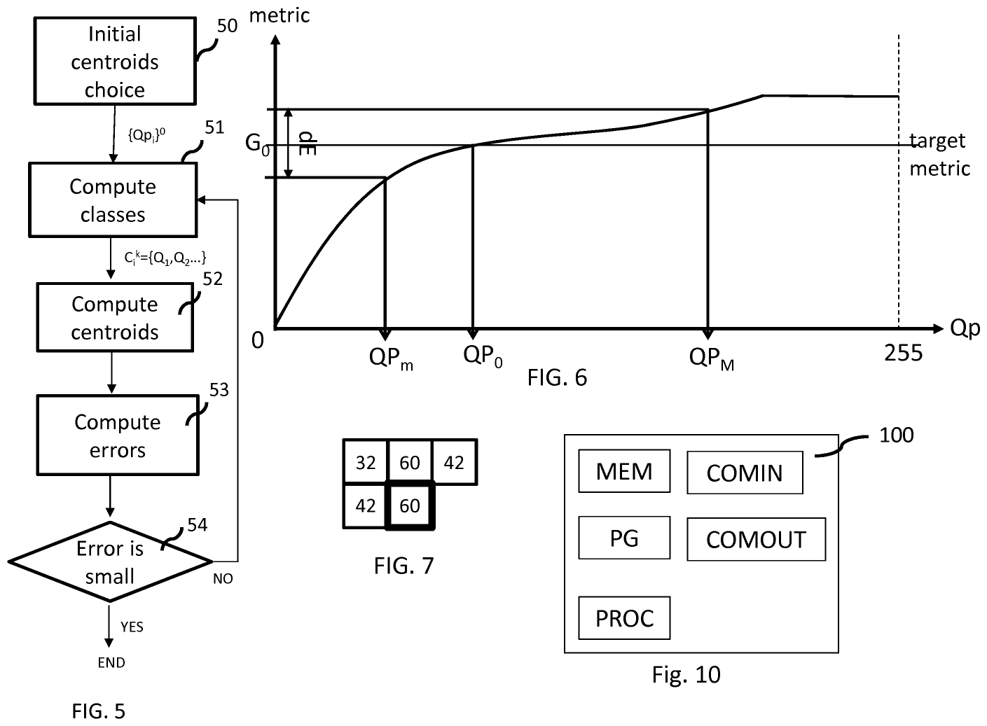

According to an embodiment of the present disclosure, before encoding the picture, the QP map is further adapted according to coding constraint in an optional step 14. Step 14 is further detailed in relation with FIG. 5. When adapting the QP map to coding constraint, the overall distortion G₀ of the picture may have changed and may not be flattened over the whole picture. Therefore, the steps 131, 132 and 14 may be iteratively performed in order to converge to a flattened overall distortion over the whole picture. Embodiments of such iterative methods are disclosed below in relation with FIGS. 4A, 4B and 4C.

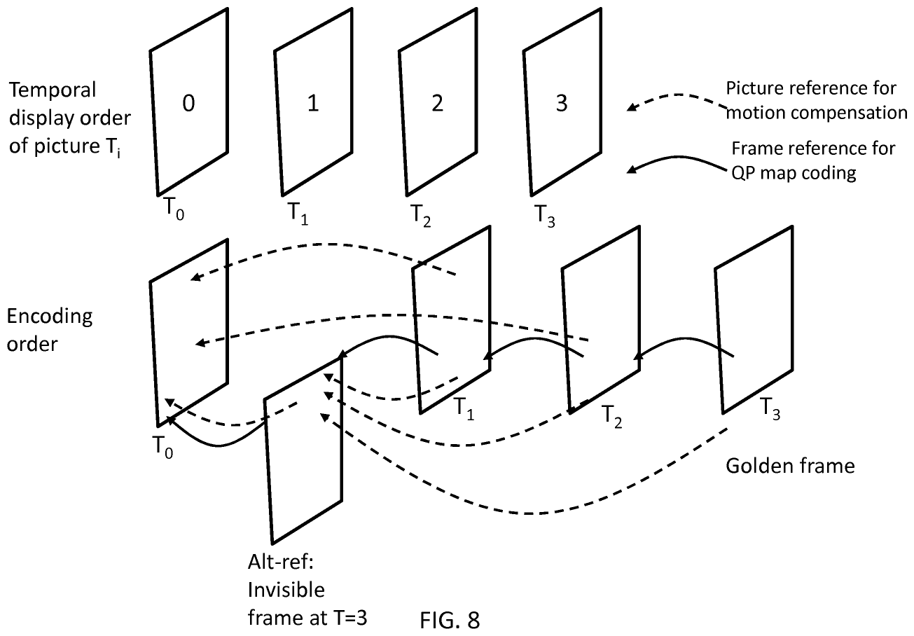

According to an embodiment of the present disclosure, before encoding the picture, the QP assigned to the blocks of the picture (QP map) are further refined in an optional step 15, for reducing the coding cost of the QP map. Step 15 is further detailed below in relation with FIGS. 7 and 8.

The goal of the offline learning (step 10 of FIG. 1) is to create a set of classes used to later classify each block of a picture to encode. The classification is based on the block trajectory (D-Q curve). The trajectory shows the change in quality function of the QP_{g}. This function is calculated by fitting a curve to the raw data points {QP,metric} obtained in the offline learning method.

FIG. 2A illustrates a flow diagram of an exemplary method for generating learning data (step 101 from FIG. 1). In step 20, a set of learning pictures is encoded using different values of QP_{g} from a set of learning QPs, ranging for instance from 0 to 255. Encoding of the learning pictures may be performed according to any video compression schemes.

In step 21, the quality of each encoded picture and at each different value of QP_{g} is assessed using a chosen metric. For instance, the WQA (wavelet-based quality assessment) metric is chosen. Such a metric gives a score of the distortion per pixel but it is computed using the whole image.

In step 22, the reconstructed pictures are partitioned into a set of blocks of the same size as in step 11 from FIG. 1. The metric, WQA in our example, is computed for each block of the pictures. For instance, the WQA metric for a block is computed as an average of the WQA metric of the pixels in the block.

Note that any other metric giving a score per block may also be suitable here.

The generating of learning data results in block raw data including for each block of a picture from the set of learning pictures a set of QP and associated metric value.

FIG. 2B illustrates a flow diagram of an exemplary method for generating trajectories classes (step 102 from FIG. 1). In step 23, the block raw data are modeled by fitting a curve to the raw data points for each block of the learning pictures.

As the chosen metric relies on a global approach, it may not vary monotonously for each block. As it is desirable that the function Mₖ(QP)=wqa is invertible, the monotony of the modeled curve is enforced. The monotony can be enforced in several ways:
“soft monotony”: the raw data are made monotonic and the fitting is made normally (for example using a Least Square Fitting of a polynomial function). The resulting trajectory is not necessarily monotonous but the resulting curve is improved.
“hard monotony”: during the fitting, a hard monotony constraint is added (for example using a convex optimization approach).

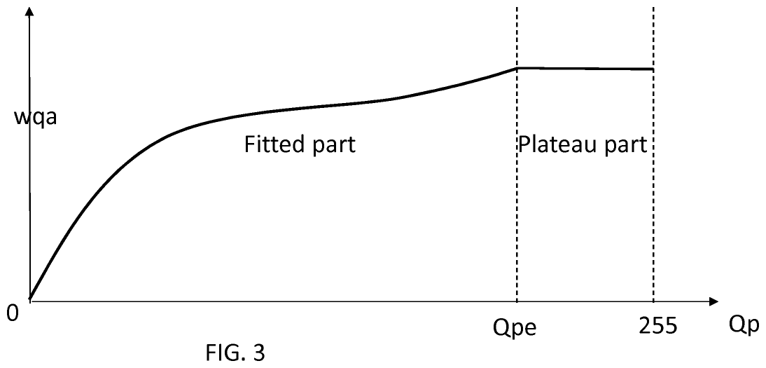

After modeling of the block raw data to trajectory, it appears that many block trajectories can be decomposed into two parts, as illustrated on FIG. 3:
an increasing distortion part (fitted part on FIG. 3)
a “plateau” part where the error is almost stable; in practice, it means all the “texture” of the block has been removed and the block quality is then constant.

Knowing these properties for coding the picture, the fitting is performed up to the plateau part, and an additional parameter QPₑ gives the start of the plateau.

In step 24, after each block of the test set has been modeled to a trajectory curve, the trajectories need to be clustered into N classes. In order to do this, a clustering algorithm, like a k-means algorithm, in the trajectories space, for example the polynomial functions here, is performed. Alternatively, the final trajectory classes can be refined by recomputing the final class trajectory using the raw data of the previous step.

Once a trajectory class has been decided, all associated trajectories samples of the class are used to compute two properties for the class: the rate trajectory and the metric trajectory. From the encoding step 20, the bitrate associated with a given QP is known for each block of the learning pictures set. So, for a given trajectory class k, a model fitting using such rate data of the blocks belonging to the class k, can be performed in order to associate a rate for each QP. A function Rₖ(QP) is thus obtained which gives the rate of a block of the class k for a given QP.

For a given class k, the relationship between the QP and the metric is given by the function Mₖ(QP) which gives the metric (or distortion) of a block of the class k for a given QP. Such function Mₖ(QP) for the class k is obtained as the centroid trajectory of the class k.

At the end of step 102, a set of trajectory classes {Tₖ}_{N} including two curves Mₖ(QP) and Rₖ(QP) is delivered for later use for block classification when encoding a video sequence.

FIG. 4A illustrates a flow diagram of an exemplary method for generating a quantization parameter map according to an embodiment of present disclosure. According to this embodiment, in order to take into account the final QP map, after adaptation at step 14 from FIG. 1, the QP of each block of a picture to encode is refined iteratively. In this embodiment, it is desired to preserve the target quality of the picture to encode, and thus not to change the target overall distortion G₀.

According to this embodiment, once the QP map has been adapted to coding constraint, the overall distortion Gᵢ for the picture to encode is computed in step 40. The overall distortion Gᵢ is computed according to the adapted QP map and the trajectory curve associated with each block of the picture. For instance, the overall distortion Gᵢ is computed as disclosed with step 131 of FIG. 1 but using for each block b of the picture, the QP_{b} assigned to the block b in the adapted QP map. That is, the distortion of the block b is thus given by Mₖ(QP_{b}) where k is the trajectory class to which the block b belongs and Mₖ is the trajectory of the class k.

In step 41, the overall distortion Gᵢ and the target overall distortion G₀ are compared. If the overall distortion Gᵢ is higher than a first threshold depending on the target overall distortion G₀, i.e Gᵢ>α×G₀, then the target overall distortion G₀ is reduced by a change factor d. This results in a small change in the input quality target of the picture.

If the overall distortion Gᵢ is lower than a second threshold depending on the target overall distortion G₀, i.e Gᵢ<β×G₀, then the target overall distortion G₀ is increased by a change factor d. This results in a small change in the input quality target of the picture.

If the overall distortion Gᵢ is between the first and second thresholds values, i.e α×G₀>Gᵢ>β×G₀, the target overall distortion G₀ is not changed and the adapted QP map is delivered to the next steps of the method for encoding the picture. For instance, α and β may be set to 0.05 or to any values (e.g. 1) leading to threshold values for which a value of the overall distortion Gᵢ being between the two thresholds is an appropriate approximation of the target overall distortion G₀.

If the target overall distortion G₀ is changed at step 41, steps 132, 14, 40 and 41 are iterated until the overall distortion Gᵢ is between the first threshold and the second threshold or until a number of iterations has been reached.

FIG. 4B illustrates a flow diagram of an exemplary method for generating a quantization parameter map according to another embodiment of present disclosure. According to this embodiment, it is desired to preserve the nominal QP decided by the encoder to encode the current picture.

In step 42, a central QP (QP_{c}) of the QP map is computed. For instance, the central QP of the QP map is the median QP of the N sorted QPs of the QP map.

In step 43, the central QP_{c} and the nominal QP_{g} are compared. If the central QP_{c} is higher than the nominal QP_{g}, i.e QP_{c}>QP_{g}, then the target overall distortion G₀ is reduced by a change factor d.

If the central QP_{c} is lower than the nominal QP_{g}, i.e QP_{c}<QP_{g}, then the target overall distortion G₀ is increased by a change factor d.

If the central QP_{c} is equal to the nominal QP_{g}, the target overall distortion G₀ is not changed and the adapted QP map is delivered to the next steps of the method for encoding the picture. Note that the ending condition here is the equality of the central QP_{c} or the oscillation of the central QP_{c} around the nominal QP_{g} in case the nominal QP_{g} is not reachable.

If the target overall distortion G₀ is changed at step 41, steps 132, 14, 42 and 43 are iterated until the central QP_{c} equals to the nominal QP_{g} or until a number of iterations has been reached.

FIG. 4C illustrates a flow diagram of an exemplary method for generating a quantization parameter map according to another embodiment of present disclosure. According to this embodiment, it is desired to preserve the nominal rate Rₜ, wherein the nominal rate is the rate of the picture using the nominal QP_{g} or directly the target rate given by the encoder.

In step 44, an overall rate R for the picture according is computed using the adapted QP map and the rate curve Rₖ(QP) associated with each block of the picture. For instance, for each block b of the picture, the rate R_{b} is given by Rₖ(QP_{b}) where k is the trajectory class to which the block b belongs and Rₖ is the rate function of the class k and QP_{b} is the QP assigned to block b in the QP map. The rate R of the picture is then given by the sum of the rate R_{b} of all the blocks of the picture.

In step 45, the rate R and the nominal rate Rₜ are compared. If the rate R is lower than a first threshold depending on the nominal rate Rₜ, i.e R<α×Rₜ, then the target overall distortion G₀ is reduced by a change factor d.

If the rate R is higher than a second threshold depending on the nominal rate Rₜ, i.e R>×β×Rₜ, then the target overall distortion G₀ is increased by a change factor d.

If the rate R is between the first and second thresholds values, i.e α×Rₜ<R<β×Rₜ, the target overall distortion G₀ is not changed and the adapted QP map is delivered to the next steps of the method for encoding the picture. For instance, α and β may be set to 0.05 or to any values (e.g. 1) leading to threshold values for which a value of the rate R being between the two thresholds is an appropriate approximation of the nominal rate Rₜ.

If the target overall distortion G₀ is changed at step 41, steps 132, 14, 40 and 41 are iterated until the rate R is between the first threshold and the second threshold or until a number of iterations has been reached.

FIG. 5 illustrates a flow diagram of an exemplary method for adapting a QP map according to an embodiment of the present disclosure. For instance, the QP map is a QP map obtained from step 13 disclosed with FIG. 1.

An objective of adapting the QP map is to transform a map of arbitrary QPs into a map of N QPs. N can be for example in a range 2 to 8 as in a VP9/VP10 coder.

According to this embodiment, adapting the QP map is performed by applying a clustering method like a k-means algorithm. However, according to the present disclosure, classical k-means algorithm cannot be used as is for adapting the QP map.

According to the present disclosure, it is to be noted that the QP of each block comes from a particular function Mₖ which may contain a plateau part, as illustrated by FIG. 3. Therefore, even if a block b is assigned a particular quantization parameter Q_{b}, if Q_{b} is in the interval [Qpe, 255], then any quantization parameter in the interval [Qpe,255] is suitable for the block b, since all quantization parameters within this interval will provide the same distortion for the block b. It is also to be noted that a difference in quality provided between 2 QPs very close can be cancelled by the overhead due to the coding of the QP map.

In the following, a k-means algorithm taking into account the above constraints is disclosed for adapting the QP map according to coding constraints.

In step 50, N initial centroids are selected wherein each class i has one initial centroid Cᵢ. For instance, the initial centroids are taken at regular interval in the range of QPs from the QP map. Step 50 delivers a set of initial centroids {Cᵢ}⁰={QPᵢ}⁰.

In step 51, the N classes are computed. In a standard k-means algorithm, the class computation is done as:

$$C ( QP ) = arg {min}_{{C}_{i}} ‖ QP - {C}_{i} ‖ ,$$

where Cᵢ is the centroid of the class i and C(QP) is the class of the quantization parameter QP. It means that each value QP is associated with the nearest centroid Cᵢ.

In order to take into account the plateau of the Mₖ function from the trajectory classes, if a given value QP assigned to a block b in the QP map belongs to the plateau part of the Mₖ function associated with the block b, the value of QP assigned to a block b is then associated with several centroids if the centroids are in the plateau interval:

$$C ( QP ) = \{ {C}_{k} \} , \\ if QP ∉ [ QPe , 255 ] , ∄ {C}_{i} ∈ [ QPe , 255 ] \{ {C}_{k} \} = arg {min}_{{C}_{i}} ‖ QP - {C}_{i} ‖$$

$$if QP ∈ [ QPe , 255 ] \{ {C}_{k} \} \vert {C}_{k} ∈ [ QPe , 255 ]$$

In step 52, the new centroids of each class determined at step 51 is computed. In the standard k-means algorithm, the centroid computation is done as:

$${C}_{k}^{n + 1} = \frac{1}{N} {\sum }_{i = 1}^{N} {QP}_{i} , {QP}_{i} \vert C ( {QP}_{i} ) = {C}_{k}^{n}$$

i.e. the new centroid Cⁿ⁺¹ of the class k is the average of all the elements of the class k at previous step n.

In order to take into account the plateau part of the function associated with the blocks, for a given value QP, the average is computed in 2 steps.

Let's denote by {QPᵢ^{np}} the values of QP which do not belong to the plateau interval and {QPᵢ^{p}} the values of QP which belong to the plateau interval:

$${D}_{k}^{n + 1} = \frac{1}{N} {\sum }_{i = 1}^{N} {QP}_{i}^{np} ,$$

where N is the number of QP which do not belong to the plateau interval. Then

$${C}_{k}^{n + 1} = \frac{1}{N + M} ( {\sum }_{i = 1}^{N} {QP}_{i}^{np} + {\sum }_{i = 1}^{M} max ( {QPe}_{i}^{p} , {D}_{k}^{n + 1} ) ) ,$$

where M is the number of QP which belong to a plateau interval, and QPeᵢ^{p} is the beginning of the plateau for the value QPᵢ^{p}. Here, when considering if a QP belongs to a plateau interval, it should be understood that the plateau interval considered is the plateau interval of the function associated with the block b to which the QP has been assigned in the QP map. Therefore, from a same value of QP in a class k, the QP value could belong to the plateau part of the function for a first block b₁ and not for a second block b₂.

According to the present disclosure, it means elements in a plateau part will participate in the centroid computation such as the elements in a plateau part move as little as possible the average of the class to which they belong.

In step 53, error for each class i of QPs is computed. In the k-means algorithm, the error for a class is computed as:

$${E}_{k} = {\sum }_{i = 1}^{N} \vert {C}_{k} - {QP}_{i} \vert$$

Using the same method as above, the error computation is adapted as follows:

$${E}_{k} = {\sum }_{i = 1}^{N} \vert {C}_{k} - {P}_{i} \vert$$

$$with$$

$${P}_{i} = {QP}_{i} if {QP}_{i} ∉ [ QPe , 255 ]$$

$${P}_{i} = max ( QPe - {C}_{k} , 0 ) if {QP}_{i} ∈ [ QPe , 255 ] .$$

In step 54, the error Eₖ is compared to a threshold. If the error Eₖ is small, that is if the error Eₖ is below the threshold, the clustering method ends, otherwise, the clustering is iterated from step 51 to 54.

According to an embodiment of the present disclosure, in the k-means algorithm, the centroid computation is classically done by averaging the elements of the class. This could result in a centroid value being a non integer value and centroid values very close from each other. In order to avoid this, after the centroid computation, each class are compared to the other one in integer values:

T_{k1,k2}=|┌Cₖ₁┐−┌Cₖ₂┐|

If the value T_{k1,k2} is below a threshold, then the classes are merged. In this case, a new class can be re-inserted at the next iteration.

According to another embodiment of the present disclosure, the number of centroids may be below the target number, of classes. Such a target number may be for instance a hard constraint of N classes equals to 8 in a VP9 encoder. The number of centroids may be below the target number for example because of classes merging as disclosed below.

According to this embodiment, the clustering method will try to insert a new centroid to well balance the centroids. The new class centroid is chosen as an initial guess to minimize the global error, for example by taking the value between the centroids the most apart.

According to an embodiment of the present disclosure, the number of different quantization parameters of the QP map depends on a target bitrate for the picture. It means that the number of QP classes, and thus the number of centroids, depends on the target bitrate for the picture to encode.

When the rate allocated for a picture is becoming low, the overhead of the cost for encoding the QP map can become too high, compared to the gain in perceptual metric for the picture. Therefore, when adapting the QP map at step 14 from FIG. 1, the maximum number of centroids is adapted so as to adapt to the cost of the QP map to the rate allocated to the picture to encode. Such an adaptation can be performed for instance by adapting the number of centroids as a function of the nominal quantization parameter QP_{g}. For instance, at low QP (high bitrate), 8 classes may be used for the QP map, at high QP (for instance QP_{g}=250), only one class may be used for the whole image, for intermediate QP value, for instance QP_{g}=125, 4 classes may be used for the QP map.

According to an embodiment of the present disclosure, in order to decrease the coding cost of the QP map, refining of the QP assigned to each block in the QP map is performed at step 15 from FIG. 1. According to other variants, such a step 15 could also be performed in any one of the embodiments disclosed with FIG. 4A, 4B or 4C.

According to this embodiment, for each block, the block trajectory, i.e the function Mₖ representing the metric (distortion) function of the QP is known, as well as the target overall distortion G₀. By setting a maximum metric error dE, it is possible to deduce for each block an admissible range of QP [QPₘ,QP_{M}], as disclosed in FIG. 6.

According to a variant, the QP map is encoded using spatial neighboring for determining a context of an entropy coder. FIG. 7 illustrates such a spatial neighboring for a current block (represented with thicker lines) of the QP map. In order to reduce the cost of the QP map, the QP for each current block should be as similar as possible to the QP of its neighboring blocks. For this, for each block of the QP map, a median QP value is computed from the QP values assigned to the neighboring blocks. If the median is inside [QPₘ,QP_{M}] interval of the admissible range of QP, the QP for the current block is set to the median.

Otherwise, for each neighbor block of the causal neighboring of the current block, if the QP value assigned to the neighbor block is inside the [QPₘ,QP_{M}] interval of the admissible range of QPs of the current block, the QP value of the current block is set to the QP value assigned to the neighbor block.

Otherwise, the QP value of the current block is kept to the original QP₀ value assigned to the block in the QP map.

According to another variant, the QP map is encoded using temporal encoding, that is using the co-located block in the last frame for the context of the entropic coder.

In order to reduce the cost of QP map, the QP assigned to a current block should be set as similar as possible as the QP assigned to the co-located block.

For this, for each of the QP map, if the value of the co-located block is inside the [QPₘ,QP_{M}] interval of the admissible range of QPs of the current block, the QP of the current block is set to the QP value assigned to the co-located block.

Otherwise, the QPvalue of the current block is kept to the original QP₀ value assigned to the block in the QP map.

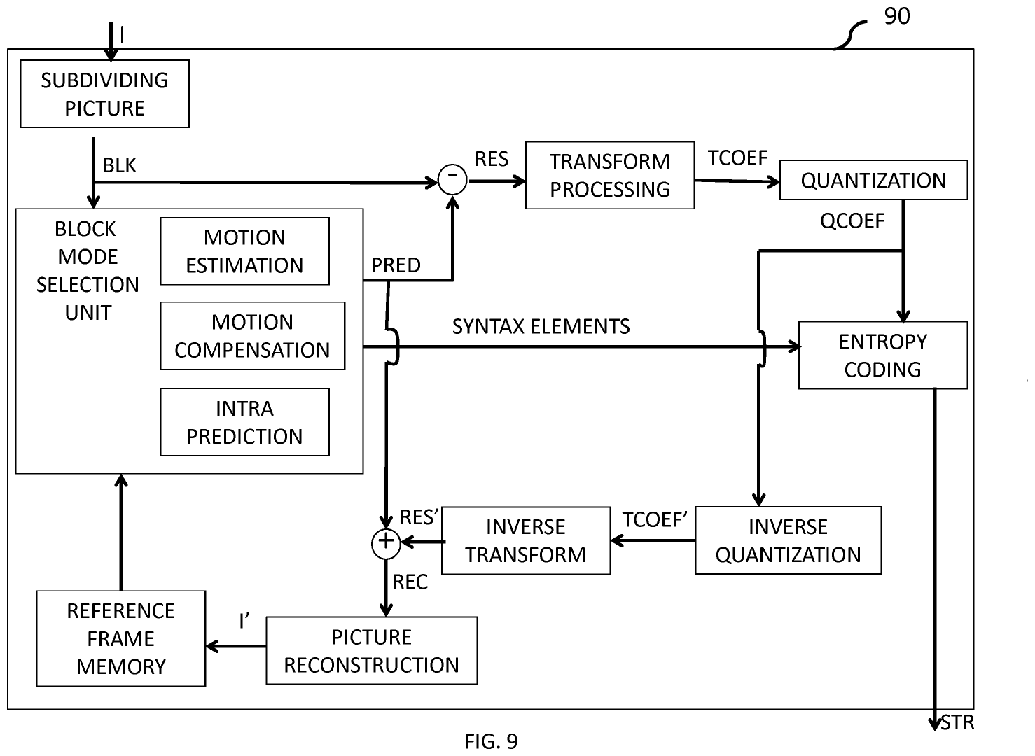

FIG. 9 illustrates a block diagram of an exemplary video encoder according to an embodiment of the present disclosure. Such a video encoder 90 performs the encoding of a set of pictures of a video into a bitstream according to an embodiment of the present principle.

The video encoder 90 performs the encoding of the pictures according to any video coding standards such as H.266, HEVC/H.265, AVC/H.264, VP9/VP10 or any proprietary video coding system.

Classically, the video encoder 90 may include several modules for block-based video encoding, as illustrated in FIG. 9. A picture I to be encoded is input to the encoder 90. The picture I is first subdivided into a set of blocks by a subdividing module. Each block BLK of the picture I is then processed for encoding. A block BLK may have size ranging from 4×4 to 128×128 pixels. Usually but not necessarily, the size of a block BLK is a power of 2.

The encoder 90 includes a mode selection unit for selecting a coding mode for a block of a picture to be coded, e.g. based on a rate/distortion optimization, such a mode selection unit including:
a motion estimation module for estimating motion between one current block of the picture to be coded and reference pictures,
a motion compensation module for predicting the current block using the estimated motion,
an intra prediction module for spatially predicting the current block.

The mode selection unit delivers prediction blocks PRED and the corresponding syntax elements to be coded in the bitstream for performing the same block prediction at the decoder. Residual blocks RES are then obtained from the blocks of the picture to be coded and the prediction blocks PRED. The residual blocks RES are transformed by a transform processing module delivering transformed residual coefficients TCOEF. The transformed residual coefficients are then quantized by a quantization module delivering quantized residual transform coefficients QCOEF.

In the present disclosure, the residual blocks RES are quantized after transformation using a quantization parameter QP assigned to the blocks in the QP map as disclosed in any one of the embodiments disclosed above.

The syntax elements and quantized residual transform coefficients QCOEF are then input to an entropy coding module to deliver coded video data.

The quantized residual transform coefficients QCOEF are processed by an inverse quantization module and inverse transform module for reconstructing residual blocks RES′. Inverse quantization of coefficients of a block is performed using the quantization parameter QP assigned to the blocks in the QP map as disclosed in any one of the embodiments disclosed above.

Prediction blocks PRED are added to the reconstructed residual blocks RES' for reconstructing blocks forming reconstructed blocks REC. The reconstructed blocks REC are stored in memory for use by a picture reconstruction module. The picture reconstruction module performs reconstruction of a decoded version I′ of the picture I from the reconstructed blocks REC. The reconstructed picture I′ is then stored in a reference picture memory for later use as a reference picture for encoding the following pictures of the set of pictures to code or for encoding subsequent blocks of the picture I.

The determining of the QP map as disclosed in any one of the embodiments disclosed with FIGS. 1 to 7 may be performed in a first coding pass of the encoder, before the mode selection unit performs mode selection for a block to be coded or before the picture I to encode is input to the encoder 90. The encoder 90, then, uses the quantization parameter assigned to the blocks in the QP map when quantizing the coefficients of a current block to encode.

When encoding a current picture I, the QP map for the current picture I determined according to any one of the embodiments disclosed above should be encoded into the bitstream such that a decoder can use the same quantization parameters for decoding the blocks of the picture I as in the encoding stage.

According to an embodiment of the present disclosure, the QP map includes a header wherein an index is assigned to each different value of QP in the QP map. That is, if the QP map includes N classes of QPs, the header includes N−1 index, index 0 corresponding to the default QP of the frame (QP_{g}). The QP map also includes a map of index wherein an index is assigned to each block of the QP map.

The QP map for a picture is then encoded by encoding data representative of the header and encoding data representative of the map of index. The map of index is encoded by the entropy coding module by using for each block of the map a spatial prediction from causal neighborhood of the block in the map or a temporal prediction from a co-located block of the index map coded with the last coded picture.

The index map may be used by the encoder to share other parameters for encoding the block of the index map. For instance in a VP9 encoder, the header disclosed above is used for assigning to a given index (also known as segment-ID in the VP9 encoder) encoding features to the blocks to which the index has been assigned in the index map. Such encoding features may be for example: restrictions on the reference frames that can be used for each index, coefficients skips, quantization parameter, loop filter strength, transform size options.

In the present disclosure, an effect of sharing the index for several encoding features is the limitation of the number of different QPs for the picture.

From one picture to another, the elements of the QP map (header, index map) may not all be encoded. Several coding modes for a QP map of a picture are possible.

The QP map may be completely refreshed, that is the index value of each block of the map as well as the header are encoded. Or, only the header of the QP map is refreshed, that is only the QP values assigned to the index are updated, the index assigned to the blocks in the index map are unchanged. Or, the QP map is unchanged, that is the same QP values are assigned to the same index and the index map is kept unchanged. In this mode, the QP map from the last coded picture is fully reused for the current picture to encode.

According to this embodiment, in order to improve the balance between rate and perceptual distortion, QP map encoding policies are proposed below according to the type of picture to encode.

For each picture to encode, QP map encoding modes that may be chosen are illustrated in table 1, with the effect on rate and distortion associated with each encoding mode, wherein the sign “+” means an increasing effect on the rate or distortion and the sign “−” means a decreasing effect.

TABLE 1

| | Effect on rate | Effect on distortion |
|---|---|---|
| Refresh header + refresh map | +++ | −−− |
| data | | |
| Refresh only map data | ++ | −− |
| Refresh only header | ~0 | |
| Refresh nothing == propagate | 0 | +++ |
| Disable QP map | 0 | ++ |

For an intra-coded picture, that is a picture coded only using spatial prediction, the header and index map of the QP map should always be refreshed, when the adaptive QP tool is enabled at the encoder.

For inter-coded pictures, that is a picture coded by reference to previous coded pictures, any one of the choices from table 1 may be valid.

Typically, for inter-coded pictures with a high rate, the index map should be refreshed. According to an embodiment of the present disclosure, in order to keep a consistent set of QPs, in the case of inter-coded pictures, the QP values assigned to the index in the header of the QP map are not changed. Only the index map is adapted. It means that for this encoding mode of the QP map, in the QP map clustering as disclosed with FIG. 5, the value of each centroid of the QP class is known.

For inter-coded pictures at low rate, the index map could be propagated without introducing any distortion. For such pictures, the additional coding cost of the QP map can be too high, especially for the pictures coded at deep temporal layer. For this type of pictures, the QP map should be disabled.

A problem by doing so is that the QP map which can be used for temporal coding for the next coded frame is lost. On the other hand, keeping the QP map, by using the propagation mode, will increase the distortion because the QP map determined for the current picture is not necessarily aligned with the QP map determined and encoded for the previous picture.

According to this embodiment, the “Refresh header only” mode is used wherein the index map is propagated, but the QP map is disabled by setting the QP of each index to a same value of QP. By doing so, the index map is still available for entropic coding for future frames but no distortion is introduced by not updating the index map.

For a particular type of pictures, known as golden frames in a VP9 standard, a special map should be built.

A golden frame is picture which is encoded using a reference to an “alt-ref” picture. An alt-ref picture is a picture encoded in the bitstream but which is an invisible picture as the alt-ref picture is not intended for display. The alt-ref picture is only coded for later use as a reference picture. The alt-ref picture is a picture temporally co-located with the golden frame, as disclosed in FIG. 8. For the golden frame, it is desirable to use exactly the block of the co-located alt-ref picture. One problem arising is that the rate-distortion choices made to encode the golden frame might be inconsistent with the rate-distortion choices of the alt-ref picture because the QP map has changed in between, as disclosed by FIG. 8.

In order to preserve the quality of the golden frame, when encoding the QP map for the golden frame, the index map is not refreshed, that is the index map of the last coded picture is used.

The header of the QP map is refreshed such as, for each index, instead of encoding a QP value, a skip-flag set to a value of 1 is encoded.

By doing so, the whole golden frame is encoded as a full skip of blocks, resulting in the exact copy of the co-located alt-ref picture.

FIG. 10 illustrates the simplified structure of an apparatus (100) for encoding a video according to an embodiment of the present principle. Such an apparatus 100 is configured to implement the method for encoding a video according to the present principle according to any embodiments disclosed above. The functional units of the encoder apparatus 100 have been disclosed in reference to FIG. 9. The structural apparatus 100 disclosed below may be configured to implement each of these functional units individually or in combination, and according to any one of the embodiments of the principle disclosed above.

The structural apparatus 100 may also be configured to implement the method for determining a QP map as disclosed in any one of the embodiments described with FIGS. 1 to 8.

According to an embodiment, the encoder apparatus 100 includes a processing unit PROC equipped for example with a processor and driven by a computer program PG stored in a memory MEM and implementing the method for encoding a video according to the present principle.

At initialization, the code instructions of the computer program PG are for example loaded into a RAM (not shown) and then executed by the processor of the processing unit PROC. The processor of the processing unit PROC implements the steps of the method for encoding a video which has been described here above, according to the instructions of the computer program PG.

The encoder apparatus 100 includes a communication unit COMOUT to transmit an encoded bitstream STR to a data network. The encoder apparatus 100 also includes an interface COMIN for receiving a picture or a video to encode.

According to the present disclosure, a method for encoding a video is disclosed. Such an encoding method includes:
associating 12 to each block of a picture from the video, a first curve giving quantization parameters as a function of distortion values,
computing 131 a target overall distortion for the picture according to a same initial quantization parameter assigned to each block of the picture and using for each block the associated first curve,
determining 132 a quantization parameter map for the picture including:
   assigning for each block, a quantization parameter given by the first curve associated with the block for the target overall distortion,
encoding 16 the picture using the quantization parameter map.

The present disclosure allows determining a quantization parameter for each block to encode based on a target overall distortion for the picture. Therefore, the picture quality of the resulting compressed video is more homogeneous.

According to an embodiment, a method for encoding a video is disclosed including:
classifying 12 each block of a picture from the video according to a set of classes of blocks, and assigning to each block a distortion-quantization, D-Q, curve associated with a respective class for each block, the D-Q curve giving quantization parameters as a function of distortion values and being invertible,
determining 131 a target overall distortion for the picture using a same initial quantization parameter assigned to each block of the picture and using the assigned D-Q curve for each block to determine a distortion for each block from the initial quantization parameter,
determining 132 a quantization parameter map for the picture including:
   determining a quantization parameter for each block by applying to the assigned D-Q curve for each block a distortion value equal to the target overall distortion, the quantization parameter map including the quantization parameter for each block,
encoding 16 the picture using the quantization parameter map.

According to an embodiment of the disclosure, the encoding method further includes adapting the quantization parameter map according to a coding constraint for coding the quantization parameter map. According to this embodiment, compression efficiency is improved since the resulting quantization parameter map (QP map) is adapted according to coding constraint. For instance, a coding constraint may be a limited number of quantization parameters to be used for the blocks of the picture. For instance, a VPx encoder allows only 8 different quantization parameters for the quantization parameter map. According to a variant, a coding constraint for coding the quantization parameter map may be a coding cost or bitrate allowed for encoding the QP assigned to each block.

According to an embodiment of the disclosure, the encoding method further includes:
computing an overall distortion for the picture according to the adapted quantization parameter map and the first curve associated with each block of the picture,
comparing the overall distortion and the target overall distortion:
   if the overall distortion is higher than a first threshold depending on the target overall distortion, reducing the target overall distortion of a first change factor,
   if the overall distortion is lower than a second threshold depending on the target overall distortion, increasing the target overall distortion of a second change factor,
iterating the acts of determining a quantization parameter map for the picture, adapting the quantization parameter map according to a coding constraint, computing an overall distortion for the picture and comparing the overall distortion and the target overall distortion, until the overall distortion is between the first threshold and the second threshold or until a number of iterations has been reached.

This embodiment allows providing a compromise between the encoding rate of the selected quantization parameters and the quality of the resulting encoded picture. This embodiment allows controlling the determination of the quantization parameter map based on the perceived quality of the picture.

According to an embodiment of the disclosure, the encoding method further includes:
computing a central quantization parameter from the quantization parameter map,
comparing the central quantization parameter and the initial quantization parameter:
   if the central quantization parameter is lower than a first threshold depending on the initial quantization parameter, reducing the target overall distortion of a first change factor,
   if the central quantization parameter is higher than a second threshold depending on the initial quantization parameter, increasing the target overall distortion of a second change factor,
iterating the acts of determining a quantization parameter map for the picture, adapting the quantization parameter map according to a coding constraint, computing a central quantization parameter and comparing the central quantization parameter and the initial quantization parameter, until the central quantization parameter equals the initial quantization parameter or until a number of iterations has been reached.

This embodiment allows controlling the determination of the quantization parameter map based on the initial quantization parameter assigned to the picture to encode. For instance, such an initial quantization parameter may be a quantization parameter assigned by a rate control mechanism of an encoder.

According to an embodiment of the disclosure, each block of the picture is associated with a second curve representing quantization parameters as a function of rate values. The encoding method further includes:
computing an overall rate for the picture according to the adapted quantization parameter map and the second curve associated with each block of the picture,
comparing the overall rate and a target rate for the picture:
   if the overall rate is lower than a first threshold depending on the target rate, reducing the target overall distortion of a first change factor,
   if the overall rate is higher than a second threshold depending on the target rate, increasing the target overall distortion of a second change factor,
iterating the acts of determining a quantization parameter map for the picture, adapting the quantization parameter map according to a coding constraint, computing an overall rate for the picture and comparing the overall rate and the target rate, until the overall distortion is between the first threshold and the second threshold or until a number of iterations has been reached.

This embodiment allows controlling the determination of the quantization parameter map based on a target rate for the picture to encode. For instance, such a target rate may correspond to a rate of the picture computed using an initial quantization parameter assigned to the picture by an encoder or a rate directly assigned by the encoder.

According to an embodiment of the disclosure, adapting the quantization parameter map uses a K-means clustering method for reducing the number of quantization parameters of the map.

According to an embodiment of the disclosure, the K-means clustering includes quantization parameter classes computing wherein for a quantization parameter assigned to a block, the quantization parameter, the quantization parameter is associated with each quantization parameter class which includes a centroid on the plateau.

According to an embodiment of the disclosure, the K-means clustering includes quantization parameter classes centroids computing wherein for a quantization parameter assigned to a block, the quantization parameter belonging to a plateau part of a first curve associated with the block, a value taken into account for computing a class centroid corresponds to a maximum value selected from a first quantization parameter of the plateau part of the first curve to which the quantization parameter belongs or a mean value of quantization parameters of the class which do not belong to the plateau part.

According to this embodiment, the quantization parameters of a class which belong to a plateau part of the QP-distortion curve will participate to the centroid of the class computation such as it moves the less possible the average of the class.

According to an embodiment of the disclosure, the K-means clustering includes error computing of a class wherein for a quantization parameter assigned to a block, the quantization parameter belonging to a plateau part of a first curve associated with the block, error is computing by taking into account a maximum value selected from a difference computed as a first quantization parameter of the plateau part of the first curve to which the quantization parameter belongs minus a value of the centroid of the class or a zero value.

According to an embodiment of the disclosure, the number of different quantization parameters of the map depends on a target bitrate for the picture. This embodiment allows adapting the overhead cost for encoding the QP map to the rate allocated to the picture. At low bitrate, the overhead cost for encoding the QP map is to high compared to the gain in perceptual metric.

According to an embodiment of the disclosure, the encoding method further includes, for at least one block of the picture, refining the quantization parameter assigned to the at least one block according to a spatial neighbor block of the at least one block or according to a block co-located with the at least one block in a last encoded frame. This embodiment allows reducing the coding cost of the quantization parameters map by taking into account spatial or temporal neighbor of a block used for entropy coding of the QP map.

According to an embodiment of the disclosure, the quantization parameter map includes a number N of different values of quantization parameter, and the quantization parameter map includes a header assigning an index to each different value of quantization parameter and a map of index wherein an index is assigned to each block of the picture. The encoding method further includes encoding the quantization parameter map including:
encoding data representative of the header,
encoding data representative of the map of index.

According to another embodiment of the disclosure, for a picture coded in an inter-frame mode, subsequent to the picture, a header of the subsequent picture is a same header as the header of the picture. According to this embodiment, the set of quantization parameters used for encoding the picture is kept consistent between pictures that are inter-frame coded.

According to an embodiment of the disclosure, for a picture coded at a predetermined temporal layer, the N different values of quantization parameter are set to a same quantization parameter value in the header. According to this embodiment, it is possible to disable the use of the QP map for pictures coded in deep temporal layer by setting a same QP to all index in the data map. For such pictures, the cost of a QP map may be too high. According to this embodiment, even if the QP map is disabled for a deep temporal layer picture, the data map is still propagated to future pictures so that the data map is available for entropy coding for future pictures. Therefore, no distortion is introduced when the data map is not updated for a picture.

According to an embodiment of the disclosure, for a first picture co-located to a reference picture coded only for use as a reference picture, the first picture being inter-coded from the reference picture, at least one second picture being coded between the reference picture and the first picture, a skip flag set to a value 1 is assigned to each index of a header of a quantization parameter map of the first picture instead of a quantization parameter value. For instance, a reference picture coded only for use as a reference picture corresponds to an alt-ref picture of a VPx compression standard, and a first picture co-located to such a reference picture and inter-coded from such a reference picture corresponds to a golden picture of a VPx compression standard. When pictures are coded in the bitstream between an alt-ref picture and a golden picture, the QP map used for coding of the alt-ref picture may have changed when coding the golden picture because of rate-distortion choices made for pictures in-between. This embodiment allows preserving the quality of the golden picture by encoding the golden picture as a full skip of blocks resulting in an exact copy of the alt-ref picture to the golden picture.

According to an aspect of the disclosure, an apparatus for encoding a video is also disclosed. Such an apparatus includes:
means for associating to each block of a picture from the video, a first curve giving quantization parameters as a function of distortion values,
means for computing a target overall distortion for the picture according to a same initial quantization parameter assigned to each block of the picture and using for each block the associated first curve,
means for determining a quantization parameter map for the picture including:
   means for assigning for each block, a quantization parameter given by the first curve associated with the block for the target overall distortion,
means for encoding the picture using the quantization parameter map.

According to the present disclosure, an apparatus 90, 100, for encoding a video is disclosed, including:
means for classifying each block of a picture from the video according to a set of classes of blocks, and assigning to each block a distortion-quantization, D-Q, curve associated with a respective class for each block, the D-Q curve giving quantization parameters as a function of distortion values and being invertible,
means for determining a target overall distortion for the picture using a same initial quantization parameter assigned to each block of the picture and using the assigned D-Q curve for each block to determine a distortion for each block from the initial quantization parameter, the target overall distortion being an average of the distortion for each block.
means for determining a quantization parameter map for the picture including:
   means for determining a quantization parameter for each block by applying to the assigned D-Q curve for each block a distortion value equal to the target overall distortion, the quantization parameter map including the quantization parameter for each block,
means for encoding the picture using the quantization parameter map.

According to the present disclosure, an apparatus 90 for encoding a video is provided including a processor and at least one memory, the processor being configured to implement any of the embodiments of the method of encoding video.

According to an implementation, the different steps of the method for encoding a video as described here above are implemented by one or more software programs or software module programs including software instructions intended for execution by a data processor of an apparatus for encoding a video, these software instructions being designed to command the execution of the different steps of the method according to the present disclosure.

A computer program is also disclosed that is capable of being executed by a computer or by a data processor, this program including instructions to command the execution of the steps of a method for encoding a video as mentioned here above.

This program can use any programming language whatsoever and be in the form of source code, object code or intermediate code between source code and object code, such as in a partially compiled form or any other desirable form whatsoever.

The information carrier can be any entity or apparatus whatsoever capable of storing the program. For example, the carrier can include a storage means such as a ROM, for example a CD ROM or a microelectronic circuit ROM or again a magnetic recording means, for example a floppy disk or a hard disk drive.

Again, the information carrier can be a transmissible carrier such as an electrical or optical signal, which can be conveyed via an electrical or optical cable, by radio or by other means. The program according to the present disclosure can be especially uploaded to an Internet type network.

As an alternative, the information carrier can be an integrated circuit into which the program is incorporated, the circuit being adapted to executing or to being used in the execution of the methods in question.

According to one implementation, the different steps of the method for encoding a video as described here above are implemented by one or more software programs or software module programs including software instructions intended for execution by a data processor of an apparatus for encoding a video, these software instructions being designed to command the execution of the different steps of the method according to the present disclosure.

According to an embodiment of the method or the apparatus for encoding a video, the target overall distortion is an average of the distortion for each block or a weighted sum of a robust absolute perceptual metric and a robust flattening score.

According to an embodiment of the method or the apparatus for encoding a video, the quantization parameter map is adapted according to a coding constraint for coding the quantization parameter map.

According to an embodiment of the method or the apparatus for encoding a video, an overall distortion is determined for the picture according to the adapted quantization parameter map and the assigned D-Q curve for each block of the picture, and the overall distortion and the target overall distortion are compared, wherein:
if the overall distortion is higher than a first value the target overall distortion is reduced by a first change factor,
if the overall distortion is lower than a second value, the target overall distortion is increased by a second change factor.

According to an embodiment of the method or the apparatus for encoding a video, the first value and second value are a function of one of the target overall distortion, the initial quantization parameter and the target rate, wherein, when the first value and the second value are a function of the target rate, the assigned D-Q curve for each block is a second assigned D-Q curve for each block.

According to an embodiment of the method or the apparatus for encoding a video, adapting the quantization parameter map uses a K-means clustering method for reducing the number of quantization parameters of the map.

According to an embodiment of the method or the apparatus for encoding a video, the K-means clustering includes determining quantization parameter classes wherein for a quantization parameter assigned to a block the quantization parameter is associated with each quantization parameter class which includes a centroid on the plateau.

According to an embodiment of the method or the apparatus for encoding a video, the K-means clustering includes determining quantization parameter class centroids wherein for a quantization parameter assigned to a block, the quantization parameter belonging to a plateau part of a first curve associated with the block, a value taken into account for determining a class centroid corresponds to a maximum value selected from a first quantization parameter of the plateau part of the first curve to which the quantization parameter belongs or a mean value of quantization parameters of the class which do not belong to the plateau part.

According to an embodiment of the method or the apparatus for encoding a video, the K-means clustering includes determining an error of a class wherein for a quantization parameter assigned to a block, the quantization parameter belonging to a plateau part of a first curve associated with the block, error is computed by taking into account a maximum value selected from a difference computed as a first quantization parameter of the plateau part of the first curve to which the quantization parameter belongs minus a value of the centroid of the class or a zero value.

According to an embodiment of the method or the apparatus for encoding a video, the number of different quantization parameters of the map depends on a target bitrate for the picture.

According to an embodiment of the method or the apparatus for encoding a video, for at least one block of the picture, the quantization parameter assigned to the at least one block is refined according to a spatial neighbor block of the at least one block or according to a block co-located with the at least one block in a last encoded frame.

According to an embodiment of the method or the apparatus for encoding a video, the quantization parameter map includes a number N of different values of quantization parameter, and wherein the quantization parameter map includes a header assigning an index to each different value of quantization parameter and a map of index wherein an index is assigned to each block of the picture, wherein the quantization parameter map is further encoded by
encoding data representative of the header,
encoding data representative of the map of index.

According to an embodiment of the method or the apparatus for encoding a video, for a picture coded in an inter-frame mode, subsequent to the picture, a header of the subsequent picture is a same header as the header of the picture.

According to an embodiment of the method or the apparatus for encoding video, for a picture coded at a predetermined temporal layer, the N different values of quantization parameter are set to a same quantization parameter value in the header.

According to an embodiment of the method or the apparatus for encoding a video, for a first picture co-located to a reference picture coded only for use as a reference picture, the first picture being inter-coded from the reference picture, at least one second picture being coded between the reference picture and the first picture, a skip flag set to a value 1 is assigned to each index of a header of a quantization parameter map of the first picture instead of a quantization parameter value.

According to the present disclosure, a method of encoding video is provided including assigning (12) a distortion versus quantization curve to a block in a picture of a video based on a perceptual metric classification of blocks, determining 132 a quantization parameter for the block based on the curve and a target distortion for the block, the target distortion being an overall target distortion for the picture and encoding 16 the block based on the quantization parameter.

According to the present disclosure, an apparatus 90, 100 for encoding video is provided including means for assigning a distortion versus quantization curve to a block in a picture of a video based on a perceptual metric classification of blocks, means for determining a quantization parameter for the block based on the curve and a target distortion for the block, the target distortion being an overall target distortion for the picture and means for encoding the block based on the quantization parameter.

According to the present disclosure, a method of decoding video is provided including retrieving a quantization parameter for a block of a picture of an encoded video bitstream, the quantization parameter being based on a distortion versus quantization curve for the block and a target distortion for the block, the distortion versus quantization curve being determined based on a perceptual metric classification of the block, the target distortion being an overall target distortion for the picture and decoding the block based on the quantization parameter. The quantization parameter may be determined according to any of the embodiments of the method of encoding video. The video may be encoded according to any of the embodiments of the method of encoding video.

According to one implementation, the different steps of the method for decoding video as described here above are implemented by one or more software programs or software module programs including software instructions intended for execution by a data processor of an apparatus for decoding a video, these software instructions being designed to command the execution of the different steps of the method according to the present disclosure.

According to the present disclosure, an apparatus for decoding video 100 is provided including means for retrieving a quantization parameter for a block of a picture of an encoded video bitstream, the quantization parameter being based on a distortion versus quantization curve for the block and a target distortion for the block, the distortion versus quantization curve being determined based on a perceptual metric classification of the block, the target distortion being an overall target distortion for the picture and means for decoding the block based on the quantization parameter. The quantization parameter is determined according to any of the embodiments of the method of encoding video. The video is encoded according to any of the embodiments of the method of encoding video.

According to the present disclosure, an apparatus 100 for decoding video is provided including a processor and at least one memory, the processor being configured to perform any of the embodiments of the method of decoding video.

According to an embodiment of the method or the apparatus for encoding video or decoding video, the quantization parameter is included in a quantization parameter map for the picture.

According to an embodiment of the method or the apparatus for encoding video or decoding video, the quantization parameter map is included in the video bitstream.

According to an embodiment of the method or the apparatus for encoding video or decoding video, the target overall distortion is an average of the distortion for each block or a weighted sum of a robust absolute perceptual metric and a robust flattening score.

According to an embodiment of the method or the apparatus for encoding video or decoding video, the quantization parameter map is adapted according to a coding constraint for coding the quantization parameter map.

According to an embodiment of the method or the apparatus for encoding video or decoding video, an overall distortion is determined for the picture according to the adapted quantization parameter map and the assigned distortion versus quantization curve for each block of the picture, and the overall distortion and the target overall distortion are compared, wherein:
if the overall distortion is higher than a first value, the target overall distortion is reduced by a first change factor,
if the overall distortion is lower than a second value, the target overall distortion is increased by a second change factor.

According to an embodiment of the method or the apparatus for encoding video or decoding video, the first value and second value are a function of one of the target overall distortion, the initial quantization parameter and the target rate, wherein, when the first value and the second value are a function of the target rate, the assigned distortion versus quantization curve for each block is a second assigned distortion versus quantization curve for each block.

According to an embodiment of the method or the apparatus for encoding video or decoding video, adapting the quantization parameter map uses a K-means clustering method for reducing the number of quantization parameters of the map.

According to an embodiment of the method or the apparatus for encoding video or decoding video, the K-means clustering includes determining quantization parameter classes wherein for a quantization parameter assigned to a block the quantization parameter is associated with each quantization parameter class which includes a centroid on the plateau.

According to an embodiment of the method or the apparatus for encoding video or decoding video, the K-means clustering includes determining quantization parameter class centroids wherein for a quantization parameter assigned to a block, the quantization parameter belonging to a plateau part of a first curve associated with the block, a value taken into account for determining a class centroid corresponds to a maximum value selected from a first quantization parameter of the plateau part of the first curve to which the quantization parameter belongs or a mean value of quantization parameters of the class which do not belong to the plateau part.

According to an embodiment of the method or the apparatus for encoding video or decoding video, the K-means clustering includes determining an error of a class wherein for a quantization parameter assigned to a block, the quantization parameter belonging to a plateau part of a first curve associated with the block, error is computed by taking into account a maximum value selected from a difference computed as a first quantization parameter of the plateau part of the first curve to which the quantization parameter belongs minus a value of the centroid of the class or a zero value.

According to an embodiment of the method or the apparatus for encoding video or decoding video, the number of different quantization parameters of the quantization parameter map depends on a target bitrate for the picture.

According to an embodiment of the method or the apparatus for encoding video or decoding video, the quantization parameter is refined according to a spatial neighbor block of the block or according to a block co-located with the block in a last encoded frame.

According to an embodiment of the method or the apparatus for encoding video or decoding video, the quantization parameter map includes a number N of different values of quantization parameter, and wherein the quantization parameter map includes a header assigning an index to each different value of quantization parameter and a map of index wherein an index is assigned to each block of the picture, wherein the quantization parameter map is further encoded by
encoding data representative of the header,
encoding data representative of the map of index.

According to an embodiment of the method or the apparatus for encoding video or decoding video, for a picture coded in an inter-frame mode, subsequent to the picture, a header of the subsequent picture is a same header as the header of the picture.

According to an embodiment of the method or the apparatus for encoding video or decoding video, for a picture coded at a predetermined temporal layer, the N different values of quantization parameter are set to a same quantization parameter value in the header.

According to an embodiment of the method or the apparatus for encoding video or decoding video, for a first picture co-located to a reference picture coded only for use as a reference picture, the first picture being inter-coded from the reference picture, at least one second picture being coded between the reference picture and the first picture, a skip flag set to a value 1 is assigned to each index of a header of a quantization parameter map of the first picture instead of a quantization parameter value.

According to the present disclosure, a bitstream formatted to include encoded data representative of a block of a picture is provided, the encoded data encoded according to any of the embodiments of the method of encoding video.

According to the present disclosure, a computer-readable program product is provided including program code instructions for performing any of the embodiments of the method of encoding video.

According to the present disclosure, a computer-readable storage medium is provided carrying a software program including program code instructions for any of the embodiments of the method of encoding video.

According to the present disclosure, a computer-readable program product is provided including program code instructions for performing any of the embodiments of the method of decoding video.

According to the present disclosure, a computer-readable storage medium is provided carrying a software program including program code instructions for any of the embodiments of the method of decoding video.

According to one embodiment, the methods/apparatuses may be implemented by means of software and/or hardware components. In this respect, the term “module” or “unit” can correspond in this document equally well to a software component and to a hardware component or to a set of hardware and software components.

A software component corresponds to one or more computer programs, one or more sub-programs of a program or more generally to any element of a program or a piece of software capable of implementing a function or a set of functions as described here below for the module concerned. Such a software component is executed by a data processor of a physical entity (terminal, server, etc) and is capable of accessing hardware resources of this physical entity (memories, recording media, communications buses, input/output electronic boards, user interfaces, etc).

In the same way, a hardware component corresponds to any element of a hardware unit capable of implementing a function or a set of functions as described here below for the module concerned. It can be a programmable hardware component or a component with an integrated processor for the execution of software, for example an integrated circuit, a smartcard, a memory card, an electronic board for the execution of firmware, etc.

It is important to note that one or more of the elements in the various methods according to the present disclosure may be combined, performed in a different order, or excluded in some embodiments while still implementing the aspects of the present disclosure. Other steps may be performed in parallel, where the processor does not wait for a full completion of a step before starting another.

It is to be understood that reference to “one embodiment” or “an embodiment” or “one implementation” or “an implementation” of the present disclosure, as well as other variations thereof, mean that a particular feature, structure, characteristic, and so forth described in connection with the embodiment is included in at least one embodiment of the present disclosure. Thus, the appearances of the phrase “in one embodiment” or “in an embodiment” or “in one implementation” or “in an implementation”, as well any other variations, appearing in various places throughout the specification are not necessarily all referring to the same embodiment.

It is to be appreciated that the various features shown and described are interchangeable. Unless otherwise indicated, a feature shown in one embodiment may be incorporated into another embodiment. Further, the features described in the various embodiments may be combined or separated unless otherwise indicated as inseparable or not combinable.

As noted before, the functions of the various elements shown in the figures may be provided through the use of dedicated hardware as well as hardware capable of executing software in association with appropriate software. Also, when provided by a processor, the functions may be provided by a single dedicated processor, by a single shared processor, or by a plurality of individual processors, some of which may be shared.

It is to be further understood that, because some of the constituent system components and methods depicted in the accompanying drawings are preferably implemented in software, the actual connections between the system components or the process function blocks may differ depending upon the manner in which the processes of present disclosure are programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications may be effected therein by one of ordinary skill in the pertinent art without departing from the scope of the present disclosure. In addition, individual embodiments can be combined, without departing from the scope of the present disclosure. All such changes and modifications are intended to be included within the scope of the present disclosure as set forth in the appended claims.

1. A method of encoding video comprising:
assigning a distortion versus quantization curve to a block in a picture of a video based on a perceptual metric classification of said block;
determining a quantization parameter for said block based on said curve and a target distortion for said block, said target distortion being an overall target distortion for the picture; and
encoding said block based on said quantization parameter.

2-6. (canceled)

7. The method according to claim 1, wherein said target overall distortion is an average of the distortion for each block or a weighted sum of a robust absolute perceptual metric and a robust flattening score.

8. The method according to claim 1, wherein said quantization parameter for said block is included in a quantization parameter map for said picture, and wherein the quantization parameter map is adapted according to a coding constraint for coding said quantization parameter map.

9. The method according to claim 8, wherein an overall distortion is determined for said picture according to said adapted quantization parameter map and the assigned distortion versus quantization curve for each block of the picture, and said overall distortion and said target overall distortion are compared, wherein:
if said overall distortion is higher than a first value, said target overall distortion is reduced by a first change factor,
if said overall distortion is lower than a second value, said target overall distortion is increased by a second change factor.

10. The method according to claim 9, wherein said first value and second value are a function of one of said target overall distortion, said initial quantization parameter and said target rate, wherein, when the first value and the second value are a function of said target rate, the assigned distortion versus quantization curve for each block is a second assigned distortion versus quantization curve for each block.

11. The method according to claim 8, wherein adapting the quantization parameter map uses a K-means clustering method for reducing the number of quantization parameters of the map.

12. The method according to claim 11, wherein said K-means clustering comprises determining quantization parameter classes wherein for a quantization parameter assigned to a block said quantization parameter is associated with each quantization parameter class which comprises a centroid on said plateau.

13. The method according to claim 11, wherein said K-means clustering comprises determining quantization parameter class centroids wherein for a quantization parameter assigned to a block, said quantization parameter belonging to a plateau part of a first curve associated with said block, a value taken into account for determining a class centroid corresponds to a maximum value selected from a first quantization parameter of the plateau part of the first curve to which the quantization parameter belongs or a mean value of quantization parameters of the class which do not belong to the plateau part.

14. The method according to claim 11, wherein said K-means clustering comprises determining an error of a class wherein for a quantization parameter assigned to a block, said quantization parameter belonging to a plateau part of a first curve associated with said block, error is computed by taking into account a maximum value selected from a difference computed as a first quantization parameter of the plateau part of the first curve to which the quantization parameter belongs minus a value of the centroid of the class or a zero value.

15. The method according to claim 8, wherein the number of different quantization parameters of the quantization parameter map depends on a target bitrate for the picture.

16. The method according to claim 8, wherein said quantization parameter is refined according to a spatial neighbor block of said block or according to a block co-located with said block in a last encoded frame.

17. The method according to claim 8, wherein said quantization parameter map comprises a number N of different values of quantization parameter, and wherein said quantization parameter map comprises a header assigning an index to each different value of quantization parameter and a map of index wherein an index is assigned to each block of said picture, wherein said quantization parameter map is further encoded by
encoding data representative of said header,
encoding data representative of said map of index.

18. The method according to claim 17, wherein for a picture coded in an inter-frame mode, subsequent to said picture, a header of said subsequent picture is a same header as the header of said picture.

19. The method according to claim 17, wherein for a picture coded at a predetermined temporal layer, said N different values of quantization parameter are set to a same quantization parameter value in the header.

20-23. (canceled)

24. An apparatus for encoding video, comprising one or more processors, wherein said one or more processors are configured to:
assign a distortion versus quantization curve to a block in a picture of a video based on a perceptual metric classification of said block;
determine a quantization parameter for said block based on said curve and a target distortion for said block, said target distortion being an overall target distortion for the picture; and
encode said block based on said quantization parameter.

25. The apparatus according to claim 24, wherein said target overall distortion is an average of the distortion for each block or a weighted sum of a robust absolute perceptual metric and a robust flattening score.

26. The apparatus according to claim 24, wherein said quantization parameter for said block is included in a quantization parameter map for said picture, and wherein the quantization parameter map is adapted according to a coding constraint for coding said quantization parameter map.

27. The apparatus according to claim 26, wherein an overall distortion is determined for said picture according to said adapted quantization parameter map and the assigned distortion versus quantization curve for each block of the picture, and said overall distortion and said target overall distortion are compared, wherein:
if said overall distortion is higher than a first value, said target overall distortion is reduced by a first change factor,
if said overall distortion is lower than a second value, said target overall distortion is increased by a second change factor.

28. The apparatus according to claim 27, wherein said first value and second value are a function of one of said target overall distortion, said initial quantization parameter and said target rate, wherein, when the first value and the second value are a function of said target rate, the assigned distortion versus quantization curve for each block is a second assigned distortion versus quantization curve for each block.

29. The apparatus according to claim 26, wherein adapting the quantization parameter map uses a K-means clustering method for reducing the number of quantization parameters of the map.
